(19) United States
(12) Patent Application Publication
(10) Pub. No.: US 2013/0219320 A1
(43) Pub. Date: Aug. 22, 2013

(54) NOVEL BOOK-LIKE INTERNET BROWSER FOR ELECTRONIC INFORMATION

(71) Applicants: Chern Hway SEET, Singapore (SG); Seng Beng HO, Singapore (SG)

(72) Inventors: Chern Hway SEET, Singapore (SG); Seng Beng HO, Singapore (SG)

(21) Appl. No.: 13/758,583

(22) Filed: Feb. 4, 2013

Related U.S. Application Data
(63) Continuation of application No. 09/617,043, filed on Jul. 14, 2000, now abandoned.

(51) Int. Cl. G06F 3/0483

(52) U.S. Cl. CPC G06F 3/0483
USPC 715/776

(57) ABSTRACT

A browsing interface for browsing Internet information that organizes information downloaded from the Internet in a page-based manner, complete with a functional thickness representation. A number of insertion methods are available for insertion of newly downloaded Internet information. A browsing data file contains information and parameters which control the display of information on the browsing interface. A streaming algorithm pre-downloads data based on predicted user data requests to minimize interruption of the browsing process.

This application is a continuation of patent application Ser. No. 09/617,043, filed Jul. 14, 2000. This application is related to copending patent application Ser. No. 08/703,404, filed Aug. 26, 1996, Ser. No. 08/992,793, filed Dec. 18, 1997, U.S. Pat. No. 5,909,207, U.S. Pat. No. 6,064,384 and copending patent application, now abandoned, Ser. No. 08/311,454, filed Sep. 25, 1994, all of which are incorporated herein by reference.

### BACKGROUND OF THE INVENTION

1. Field of the Invention

The present invention relates to a human-computer interface that is used for the browsing of information on the Internet. The present invention organizes the information downloaded from the Internet into the form of a book. The present invention organizes the information downloaded from the Internet in such a way that it allows a rapid and holistic view of the downloaded information, as well as rapid and convenient access to and search for items in the downloaded information.

2. Description of the Prior Art

Currently, documents available on the Internet are usually represented in the format of “hypertext.” Each hypertext “page” can be arbitrarily long, which may or may not be fitted within one computer monitor screen. Pages of the hypertext are linked by “hyperlinks”—on each page of a hypertext, there might be one or more “links” in the form of pictures or words which when selected and clicked on (with, say, an input device such as a computer mouse) will cause the page that the hyperlink is linked to to appear on the monitor screen, in replacement of the earlier hypertext page. This is the mechanism by which, say, the two most popular Internet browsers—Microsoft INTERNET EXPLORER® and Netscape COMMUNICATOR®—function.

For the viewing of a hypertext page that is longer/larger than can be contained within one screen, a mechanism is provided to scroll the page up and down (and/or left and right) or to jump to a particular point in the page (through the use of, for example, a computer mouse coupled with scroll bars at the edges of the page displayed on the screen). Sometimes, hyperlinks on one section of the page may point to another section of the same page, and when the hyperlink is clicked, the destination section jumps into view.

However, it is well known in human-computer interface research that hypertext suffers from a number of problems. Chief among these is the navigation problem—the reader of a hypertext document covering several pages often gets lost in navigating among the hypertext pages. In regard to the entire collection of hyperlinked pages that is the entire hypertext document, he/she often does not know where particular pages are in the hypertext, what else is in the hypertext document, and how to go from one point in the document to another point in the document.

Another significant frustrating disadvantage of Internet surfers (people who read Internet documents) is that, despite the fact that a “forward” or “back” button is available on the Internet browser (such as Microsoft's INTERNET EXPLORER or Netscape's COMMUNICATOR®), surfers often have problems returning to a particular hypertext page. The reason is that the hypertext pages are linked by a large number of links with no particular sequential or ordered multi-level organization. However, the “forward” and “back” buttons presume a sequential forward-backward organization. Thus, Internet surfers are often lost when trying to read a document with a complex organizational structure using only simple commands to proceed through the document.

Sequential organization of information is found in the traditional book—pages are linked sequentially one after another. Though mechanisms for jumping across many pages are available, such as by selecting a page from the side of the book and flipping to the page, the information in the book is still laid out in an orderly, sequential manner. Also, despite the fact that a reader/browser can jump to anywhere in the book at any time in any random order, the reader/browser has a good understanding of where he/she is in the book. In the process of flipping and jumping about, location information is captured by the thickness of the book on both sides of a selected page, as well as during the flipping process. The flipping of the pages allows one to know the direction of movement through the document as well as how much one has moved through the document. The advantage of knowing where one is at any given time greatly reduces navigation problems, if not eradicates them entirely.

Furthermore, one can also very quickly and easily obtain a grand overview of all the information in the book by flipping about. On the other hand, a person is not only bound to get lost when browsing a 1000-page hypertext document, there is also the problem of obtaining a grand overview of the information involved.

Hence the major defects with hypertext—the navigation problems—are not present in the traditional book. One can be browsing a book of 1000 pages, and yet one can still comfortably know where one is, what else is in the book, and how to get from one point to another.

As a result of these problems, people browsing large amount of information on the Internet often prefer to print the hypertext pages out on paper, and then hold these sheets in their hands and browse through them much like the way they browse through a book to look for and read information of interest.

The interaction between a reader/browser and printed material in a book is a subtle and complicated process. To begin with, material in a book is presented in a sequential order, with a continuity of material from page to page, and there is also a hierarchical structure in the material presented (as the material is organized into chapters, sections, subsections, etc.) because ideas in the material are related to each other in some kind of conceptual hierarchy. The human perceptual system inputs data in a sequential manner, and after a book is read from the beginning to the end in a sequential fashion, the brain then recreates the conceptual hierarchy after viewing the material involved. However, very often one does not read a book (or input the material involved) from the beginning to the end because (a) one wants to have an overview of the material present; (b) one is searching for something of interest to him/her; or (c) one is interested in reading only portions of the book (in the case of, say, reading the manual to understand how to operate something). In these cases, one browses through the subject book to find the material of unique interest to that reader.

Two basic things are achieved in the browsing process. First, the browser has a glimpse of what the contents of the book document are. Second, the browser has an idea of approximately where the items of interest are so that the browser can (a) return to look for them later when needed, and (b) have an understanding of the relationships between the material currently being viewed and other material (i.e., an understanding of the hierarchical structure involved). When browsing a book document, many finger-operations are required of the browser in order to flip through the pages and, together with the inherent sequential order imposed by the pages, very quickly allow the browser to have an understanding of the nature, location and organization of the material involved.

Similarly, the vast amount of information available on the Internet can benefit from the organizational structures normally found in a book—the sequential page-by-page organization of information. These organizational structures give rise to two major benefits: 1. navigational problems are greatly reduced—i.e., they allow the browser to know where he/she is, what other information exists, and how to get from one section of information to another in the case of browsing through hypertext pages, and 2. a good overview of the included information becomes easily available.

The sequential organization of information is not to replace the hyperlink mechanism available in a hypertext document. Instead, it is complementary to it. Other than having the pages linked in a sequential manner, and other than having them randomly accessible through the thickness of the “book-like” representation, the hyperlink mechanism is retained and would add value to the browsing process. The advantage of the hyperlink is that the users can move very quickly from one page to another related page. However, in the book-like, page-based sequential organization, when a hyperlink is selected and triggered, the process of going to the location pointed to by the hyperlink will emulate the physical process—there will be flipping animation. showing a thickness across the screen proportional to the amount of information between the location of the hyperlink and the location pointed to by the hyperlink. This will aid users in knowing where they are and where they are going and, combined with the traditional processes of hyperlinking, will aid the process of searching for information.

The hypertext linking mechanism is in some way an electronic version of the traditional index usually found at the end of a book. When one is reading the pages of a book and when one finds a keyword or topic of interest, one may flip to the index at the end and from there go to another page that contains related keywords or topics. This two-step process—first to the index page then to the destination page—is achieved in one step in the hypertext linking mechanism. However, unlike in the case of the physical paper book, there is no need to physically flip the pages to get to where one wants to go to in the electronic hypertext linking process. The electronic “goto” is effortless and instantaneous.

However, there is a major difference between the hypertext linking process and the traditional indexing mechanism in the paper book. In the hyperlinking process, typically the link leads one to a SINGLE destination. On the other hand, when one looks at an entry for a topic in the index of a paper book, one sees multiple destinations. And then, one can choose any one of the destinations to go to. Very often these different destinations may contain different depths of coverage of a particular topic or coverage of the topics from different angles. The book-like representation allows the display of multiple destinations on its thickness for the browser to select the desired destination.

Therefore, the inventor has recognized that there exists a need for a novel method for browsing information on the Internet. Basically, it is a book-like, page-by-page sequential organization of information complete with thickness representation and mechanisms to select destination pages on the thickness representation.

Together with the book metaphor of representing information for Internet browsing comes the library metaphor of organizing a large number of books into a “library.” Thus, in the new Internet browser, one can create a library of “books” containing previously browsed information. These books may contain related information, information browsed in the same session of browsing activity, or a combination of both. Together with the book-like interface for browsing information on the Internet, this further organization of information browsed on the Internet will add tremendous value to the browsing process.

### SUMMARY OF THE INVENTION

In view of the aforementioned short-comings of presently available schemes for browsing through information available on the Internet presented in the form of hypertext, one objective of the present invention is to provide an Internet browsing interface that is very much like the traditional paper book—with page turning and thickness representation, etc. so that the information on the Internet is better organized for the purpose of viewing, reading and searching. This is called the “Internet browsing book.” With this method and mechanism of representing information on the Internet, users have a good grasp of 1. where they are, 2. what other information exists, and 3. how to get from one section of information to another. This solves the so-called “navigation problems” often associated with the hypertext method of representing Internet information that often causes Internet surfers to become lost.

Another objective of the invention is to provide a number of methods for the insertion of new information into the Internet browsing book as new information is downloaded from the Internet through either the selection and activation of hyperlinks on currently seen pages or through the input of an URL in an URL address field on the computer screen.

Yet another objective of the invention is to provide a variety of bookmark types to facilitate the bookmarking of and subsequent searches for information in the browsing book.

A further objective of the invention is to provide a control interface on or around the Internet browsing book to allow the user to activate a number of operations related to the browsing of information downloaded from the Internet.

A yet further objective of the invention is to provide a mechanism to view information downloaded from the Internet in a “centerfold” format that satisfies both the requirements of using the book-like representation as well as having the ability to display the common “landscape” dimensions (width larger than height) of most Internet Web pages.

Another objective of the invention is to provide an extension to the existing electronic book format—the OEB format—for encoding the unique parameters associated with the transmission of information across the Internet to be viewed in our unique Internet browsing book.

Yet another objective is to provide a “book shelf” interface for the display of existing Internet browsing books and the parameters used to control the display or information in those browsing books.

A further objective of the invention is to provide an algorithm for streaming data across the Internet in anticipation of the use of those data by the unique Internet browsing book to view those data. This will minimize the disruption of the browsing of information on the Internet due to limited bandwidth of transmission of data across the Internet.

Another objective is to provide a special interface, a “search report,” to contain and display information searched for on the Internet that is superior to the current mechanisms for displaying information searched for on the Internet.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1A is a top perspective view of an exemplary Internet browsing book displayed on a computer screen that is used to display information downloaded from the Internet;

FIG. 1B is a top perspective view of the exemplary Internet browsing book displayed on the computer screen during the process of jumping a number of pages ahead in the book;

FIG. 1C is a top perspective view of the exemplary Internet browsing book displayed on the computer screen in the process of flipping to the next page;

FIG. 1D is a top perspective view of the exemplary Internet browsing book displayed on the computer screen during the process of flipping many pages simultaneously;

FIG. 1E is a top perspective view of the exemplary Internet browsing book displayed on the computer screen during the process of selecting a page where the thickness is expanded to allow finer resolution during page selection;

FIG. 2A is a top perspective view of the exemplary Internet browsing book just before the start of a browsing session before information is being downloaded from the Internet;

FIG. 2B is a sequence of top perspective views of the exemplary Internet browsing book in the process of downloading some new information from the Internet in response to the entry of a URL;

FIG. 2C is a sequence of top perspective views of the exemplary Internet browsing book in the process of downloading some new information from the Internet in response to the selection and activation of a hyperlink on the page of the exemplary Internet browsing book;

FIG. 2D is a top perspective view of exemplary different modes of displaying information in the Internet browsing book;

FIG. 2E is a top perspective view of the exemplary Internet browsing book showing an exemplary mode of displaying information downloaded from the Internet that occupies more than one page;

FIG. 2F is a top perspective view of the exemplary Internet browsing book showing a first exemplary mode of inserting newly downloaded information from the Internet;

FIG. 2G is a top perspective view of the exemplary Internet browsing book showing a second exemplary mode of inserting newly downloaded information from the Internet;

FIG. 2H is a top perspective view of the exemplary Internet browsing book showing a third exemplary mode of inserting newly downloaded information from the Internet;

FIG. 2I is a top perspective view of the exemplary Internet browsing book showing a fourth exemplary mode of inserting newly downloaded information from the Internet;

FIG. 2J is a top perspective view of the exemplary Internet browsing book showing three other exemplary modes of inserting newly downloaded information from the Internet;

FIG. 2K is a top perspective view of the exemplary browsing book showing other exemplary modes of inserting newly downloaded information from the Internet;

FIG. 3A is a top perspective view of the exemplary Internet browsing book showing various exemplary controls available on and around the exemplary Internet browsing book to effect a number of operations associated with browsing information on the Internet using the browsing book;

FIG. 3B is a top perspective view of the exemplary Internet browsing book showing flipping to the next page with a “centerfold” mode of display of information on the current page;

FIG. 4 is a diagram showing an exemplary format used in conjunction with our Internet browsing book for the representation and coding of book parameters that is an extension to the existing OEB format;

FIG. 5A is a top perspective view of an exemplary Internet browsing system that caters to both hypertext-based as well as page-based information;

FIG. 5B is an example library shelf that keeps track of the parameters that control the display of information in the browsing books by the exemplary browsing system;

FIG. 6 is a flowchart that details a preferred exemplary algorithm used for streaming/pre-downloading information by a person browsing through information on the Internet using an Internet browsing book according to the current invention;

FIG. 7 is a top perspective view of an exemplary search report displayed in a exemplary book format generated by searching through information on the Internet.

### DETAILED DESCRIPTION OF THE PREFERRED EMBODIMENTS

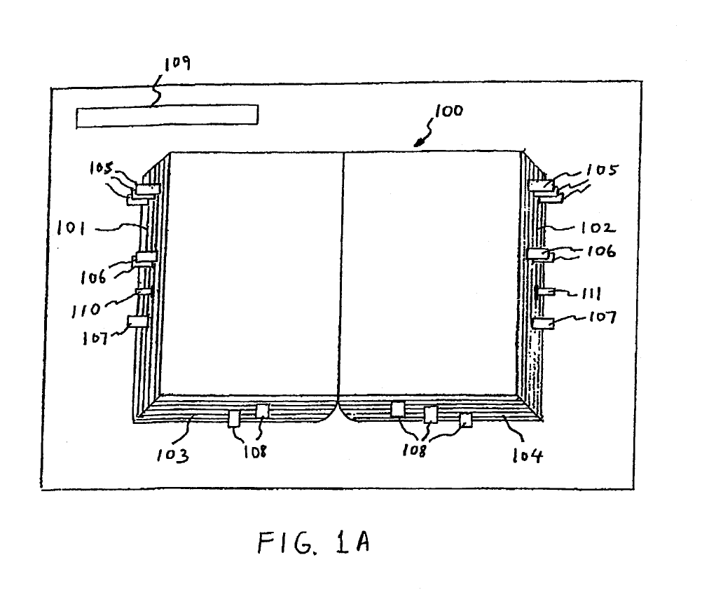

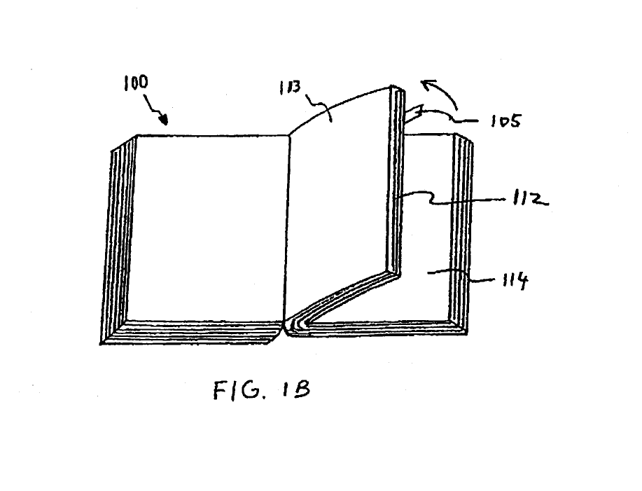

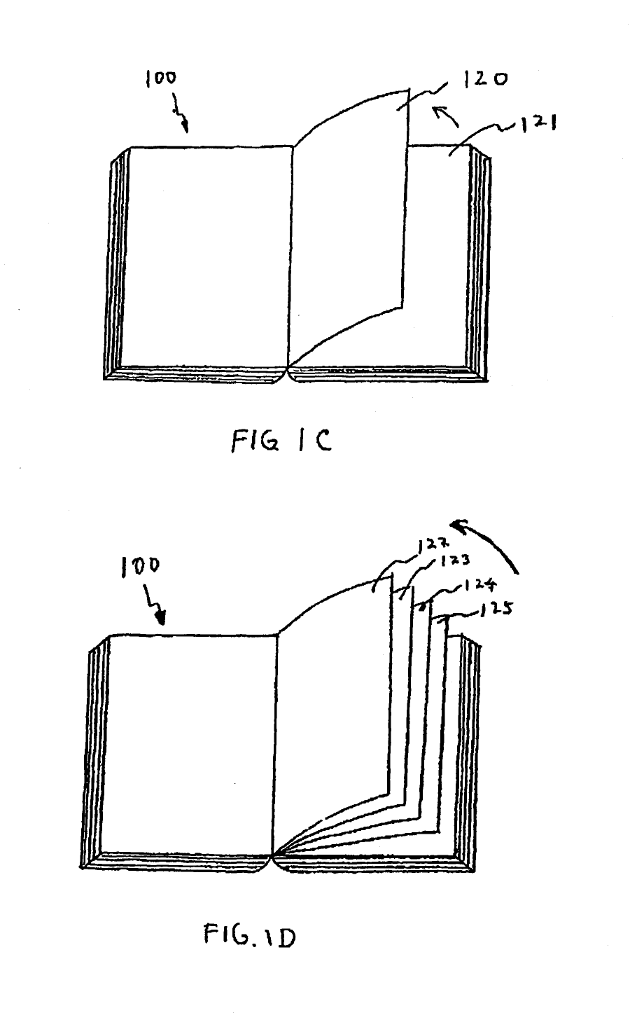

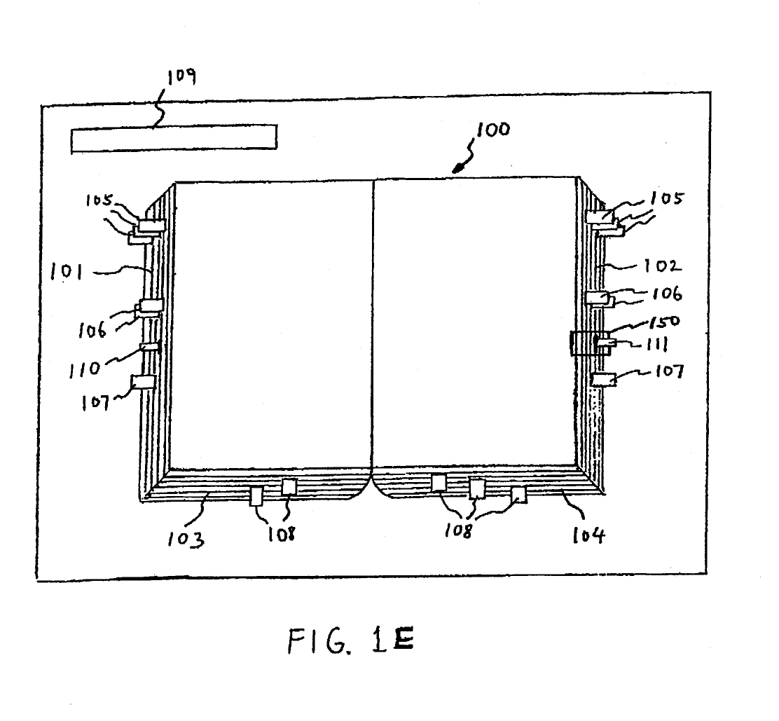

Referring now to the drawings, wherein like reference numerals designate identical or corresponding parts throughout the several views, and more particularly to FIG. 1A thereof which depicts one embodiment of the Internet browser interface. Basically, the information downloaded from the Internet is displayed on two pages as in an opened book. At this stage, a number of Internet pages have been browsed through and collected in the “Internet browsing book” 100. The amount of material before and after the current pages (the pages in view) is shown as varying thicknesses on the left and right sides (101 and 102), respectively (as well as the left and right bottom edges (103 and 104)), of the book. On the left and right thicknesses (101 and 102) are shown a number of bookmarks (105-107) that bookmark some of the pages that have been viewed earlier. There are three types of bookmarks on these thicknesses. They are page-bookmarks 105, annotation bookmarks 106, and finger bookmarks 107. These will be explained shortly. On the bottom thicknesses (103 and 104) are shown a number of keyword bookmarks 108. A URL (Universal Resource Locator) field 109 above the browsing book 100 allows URL addresses to be entered.

In order to allow the user to select any desired page, jump cursors 110 and 111 are provided on the left and right thickness (101 and 102). The user, using a mouse or other control, can move the left or right jump cursors (110 and 111 respectively) up and down the left or right thicknesses (101 and 102 respectively). The page number may appear on the tag of the jump cursor to display the page selected by the jump cursor. When the user has decided to jump to a certain page using the jump cursor to select that page, he/she can use the mouse or other input device to activate the jump.

FIG. 1B depicts the process by which a certain selected page in the browsing book 100 is jumped to. This jump may have been either activated by the selection of a bookmark (e.g. page-bookmark 105) or by the jump cursor (e.g., jump cursor 110 or 111). The thickness 112 between the page originally in view 113 and the page jumped to 114 is shown to move across the computer screen in continuous animation, much like in the case of the physical book.

FIG. 1C depicts a process by which one page 120 in the browsing book 100 is being flipped. The page 120 can be shown to bend and move across the computer screen to reveal the underlying page 121.

FIG. 1D depicts a process by which, because of increased speed of moving through the browsing book 100 by flipping the pages, more than one page (122-125) is shown to be moving across the computer screen at the same time. The user can select to freeze all the pages in motion.

FIG. 1E depicts a special jump cursor mode in which the thickness of the page in the region of the jump cursor (110 or 111) is selected to enter a mode of fine adjustment. Due to the resolution of the screen, if the thickness of the page (101 or 102) is used to represent, say, a large number of pages while the thickness representation on the computer screen may only have a limited number of pixels, the movement of the jump cursor (110 or 111) over the thickness (101 or 102 respectively) in pixel-incremented steps may not allow the user to select some of the pages. Therefore, a fine adjustment mode is necessary. One embodiment is to right click on the jump cursor (say jump cursor 111), and the thickness region around the jump cursor 111 is “expanded” and represented as a rectangle 150. The thickness represented in the rectangle 150 represents a subset of the pages represented by the full thickness 102, around the page currently pointed to by the jump cursor 111. When the jump cursor 111 is moved up and down the thickness within the rectangle 150, it can access the pages to a finer level than on the original thickness 102. Further “enlargements” of the thickness 102 is also possible that leads to even finer access of the pages on the thickness 102.

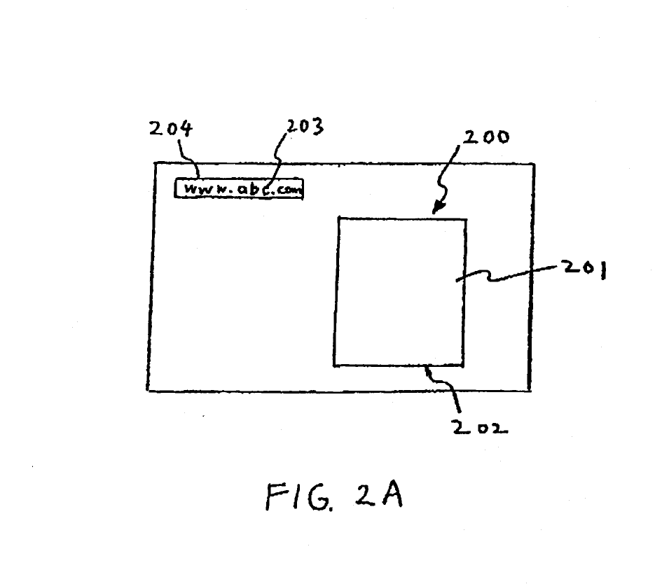

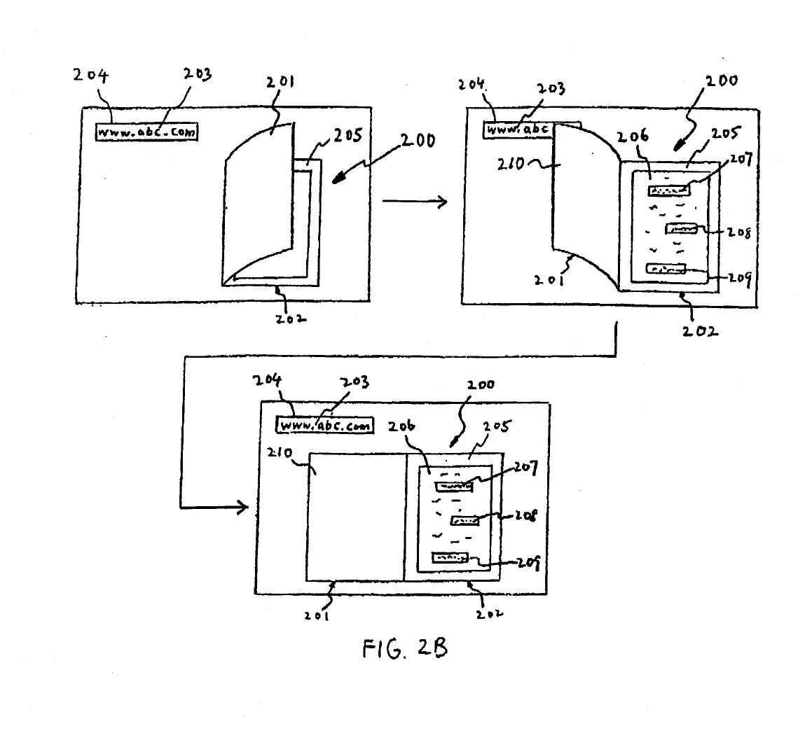

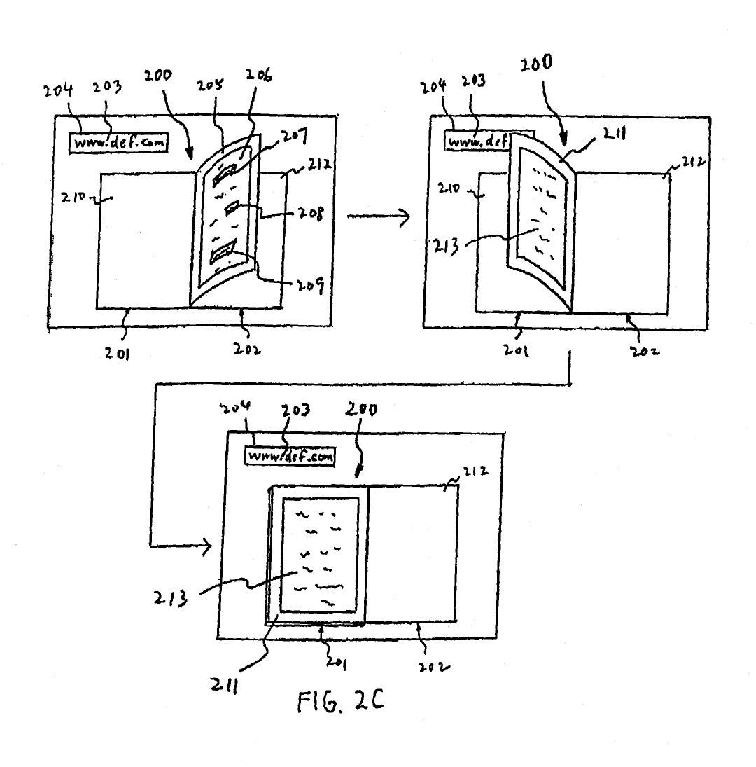

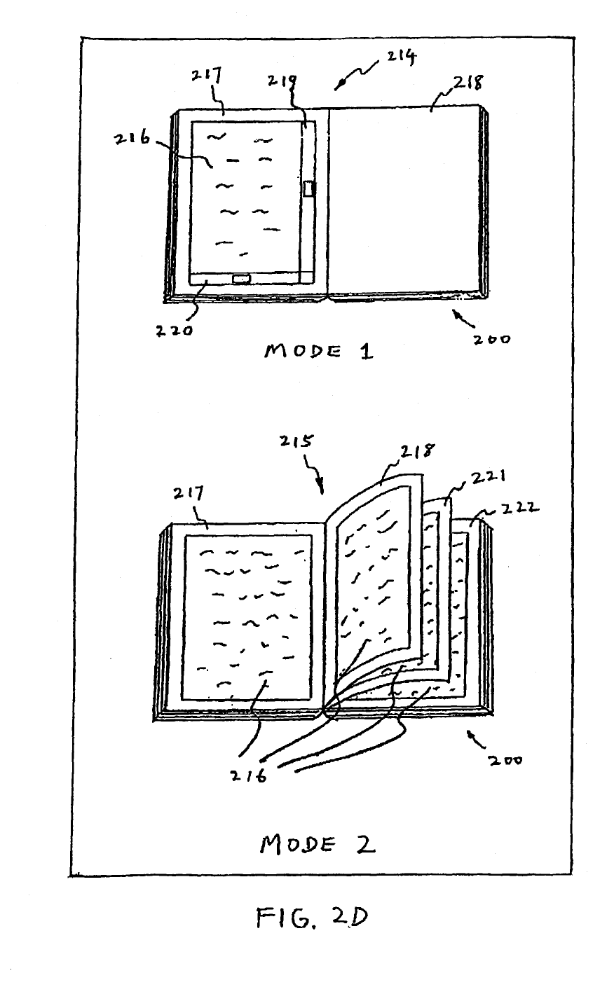

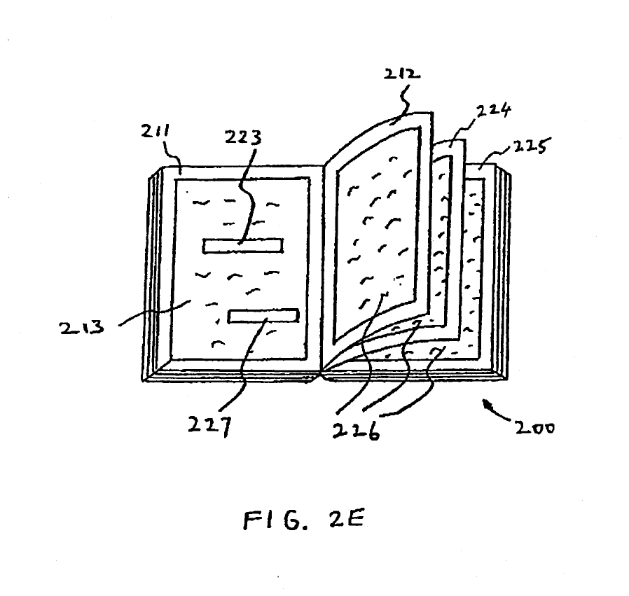

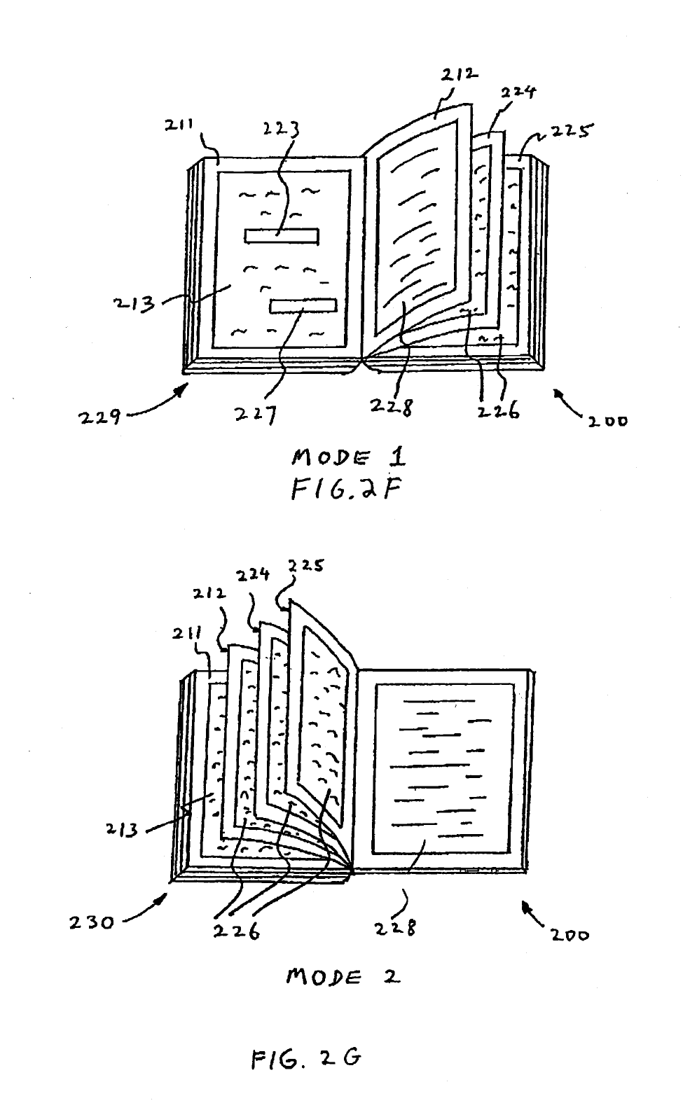

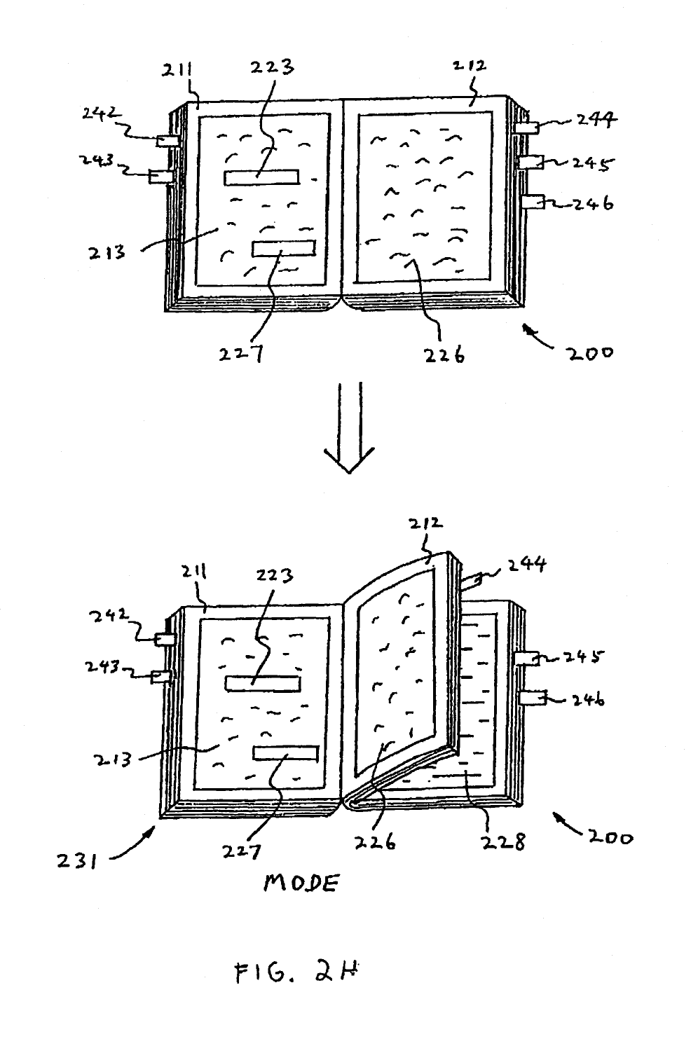

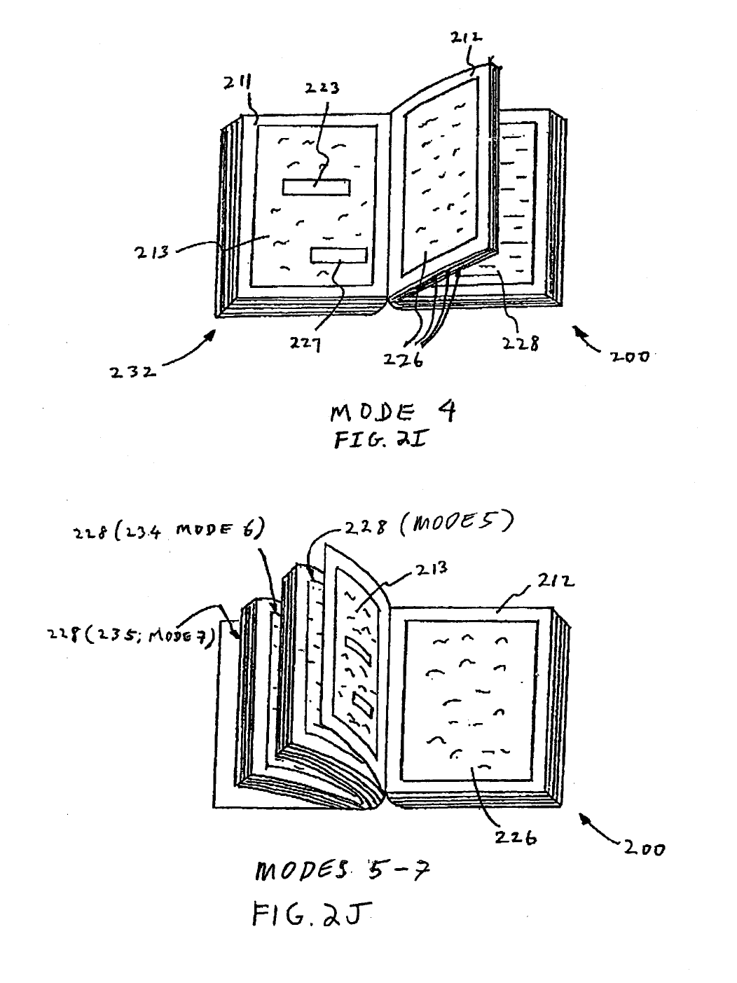

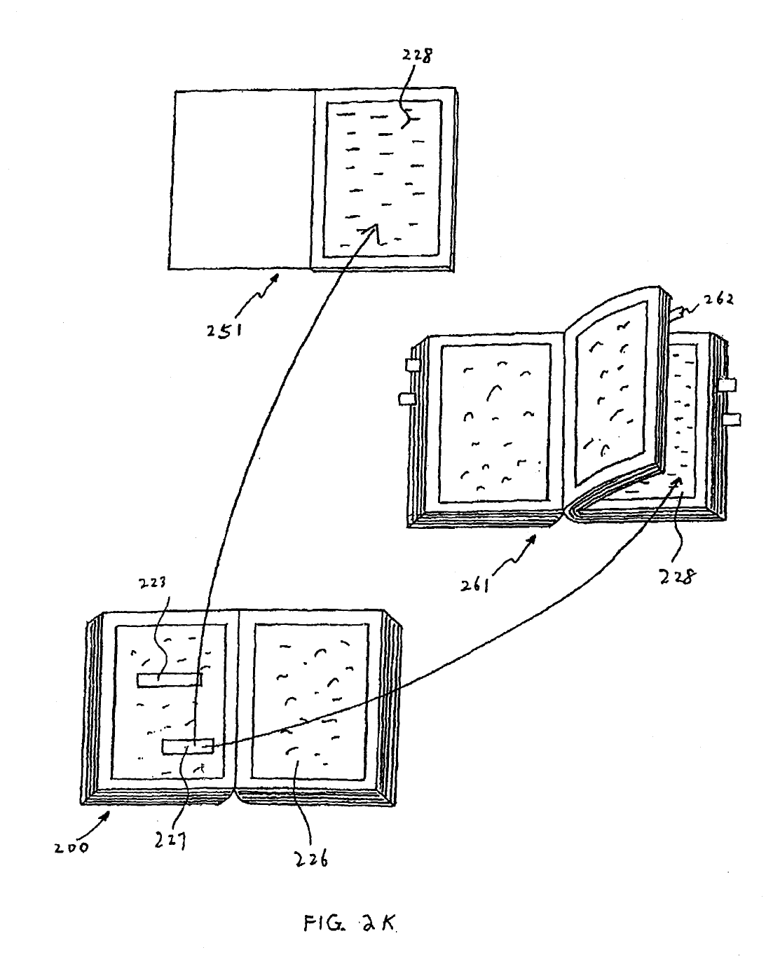

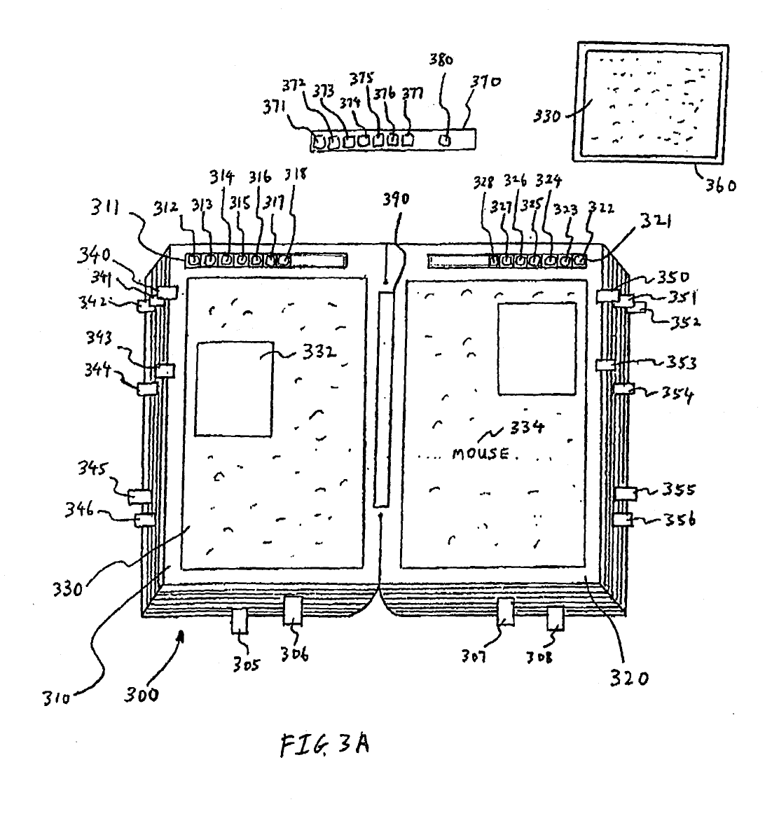

FIG. 2A-2K depict example processes by which the browsing book 100 is created. FIG. 2A shows the beginning of an Internet browsing process when a browsing session is launched. A book 200 is created and displayed. At this time the book consists only of the front cover 201 and back cover 202.

FIG. 2B depicts what can happen when a URI, 203 (Universal Resource Locator—the address of a “Web page”) is entered into the field 204 on the top of the display and activated. The front cover 201 of the browsing book 200 is flipped open, revealing a new page 205 in the book 200. On the new page 205, the web page 206 of the URL 203 is displayed. The left hand page (210) is empty.

A number of hyperlinks (207-209) is available on the web page 206. FIG. 2C depicts what happens when hyperlink 207 on the web page 206 (FIG. 2B) is selected and activated. The page 205 flips to reveal two more new pages (211 and 212) added to the browsing book 200. On the page 211 are the contents of the web page 213 pointed to by the hyperlink 207 (FIG. 2B). The left side of the Internet browsing book 200 now indicates a relatively small thickness because of the limited number of pages added to the left side. As more and more contents are brought into the Internet browsing book 200, it would acquire increased thicknesses on both sides.

Two example modes for displaying Web contents are illustrated. FIG. 2D depicts these two example modes (214 and 215). In Mode 1 (214), the web contents 216 are displayed onto one page (page 217), whether or not the web contents 216 can fit onto one page or not. In the case that the contents exceed the size of one page, a vertical scroll bar 219 and a horizontal scroll bar 220 are made available and can be used to scroll up and down or left and right respectively to view various parts of the web contents 216. In Mode 2 (215), Web contents 216 that cannot be fitted onto a single page are spread over two or more pages (217, 218, 221, 222). The contents may be displayed at the front as well as at the back of the pages.

FIG. 2E depicts an example situation in which a hyperlink 223 on the left hand page 211 is being selected and activated. The contents 226 that the hyperlink 223 points to are shown to spread over more than one page (212, 224, 225) [Mode 2 (215) described in FIG. 2D]. The contents may be displayed on the front as well as the back of these pages.

At this point, suppose another hyperlink 227 on the left hand page 211 is being selected and activated. There are four convenient places where the contents 228 that the hyperlink 227 points to can be displayed. FIG. 2F-J shows seven example modes (229-235) for display of newly received contents pointed to by hyperlink 227. In Mode 1 of FIG. 2F, the NEXT-PAGE MODE, (229), the newly received contents 228 are displayed right after the page 211 where the hyperlink 227 resides, in this case, page 212. (If the contents 213 in which hyperlink 227 resides spread over more than one page, then the newly received contents 228 could be displayed right after the last page containing the contents 213.) This way, the existing contents 226 have to be moved forward one page to make way for newly received contents 228.

Alternatively, if the newly received contents 228 spread over more than one page, the existing contents 226 could move forward more than one page to accommodate newly received contents 228.

In Mode 2 of FIG. 2G, the LAST-PAGE MODE, (230), the newly received contents 228 are displayed right after the last page containing the existing contents 226 if the contents 226 are the only contents after contents 213 that contains the hyperlink 227.

Alternatively, the newly received contents 228 can be displayed right after the last page of whatever existing contents there may be after the contents 213 that contains the hyperlink 227.

In Mode 3 (231, FIG. 2H), if a large amount of contents have been previously received both before and after the contents 213 that contain the hyperlink 227, and these previously received contents have been bookmarked, say, with bookmarks 242-246, the user can first select any bookmark (say, bookmark 244) and then select and activate the hyperlink 227. The newly received contents 228 will then be inserted where the selected bookmark 244 is positioned.

In Mode 4 of FIG. 2I (232), the newly received contents 228 are inserted right after the next set of contents 226, which is the set of contents right after contents 213 that contains the hyperlink 227, even though there may be other contents after contents 226. The next set of contents 226 may be defined by the collection of contents belonging to, say, the same Web site.

In Mode 5 (233, FIG. 2J, BEFORE-CURRENT-PAGE MODE), the newly created contents 228 are inserted just before the current contents 213 that contain the hyperlink 227. In Mode 6 of FIG. 2J (234, BEFORE-PREVIOUS-SET MODE), the newly received contents 228 are inserted just before the contents just before the current contents 213 that contains the hyperlink 227. In Mode 7 of FIG. 2J (235, FIRST-PAGE MODE), the newly received contents 228 are inserted just at the very beginning of the Internet browsing book 200.

There are other modes of insertion. The newly received contents 228 can also be inserted into 1. any specified page (by using page number, name of page, or a “jump cursor” pointing to the page on the thickness of the book), 2. before or after any specified contents (say, by the contents' name), 3. any number of pages before or after the current page 211, or 4. before or after any number of specified sets of contents.

The newly received contents 228 can also be inserted into a new browsing book 251 or a separate existing browsing book 261 using some of the above modes of insertion (say, by selecting a bookmark 262 (Mode 3, 231) or by specifying a page using the methods described in the paragraph above), as depicted in FIG. 2K. In the process of inserting new contents through one of the modes described above, typically the browsing book will automatically and immediately flip to the page(s) where the new contents are to be displayed (unless this process is specifically inhibited by the user through the selection of a “do-not-jump-to-new-contents” option—i.e., the insertion of new contents takes place without an immediate subsequent jump to the page(s) where the new contents reside to display the new contents). If there is a need to jump to a page different than the one that is currently in view on the computer screen to show the newly inserted contents, then an animation showing the flipping to that page, complete with the movement of the intervening thickness 112 across the computer screen, is shown, much like that which is depicted in FIG. 1B.

This is the case whether the new contents are inserted in the same browsing book as the one where the hyperlink that points to these new contents resides, or if the new contents are inserted in a different browsing book. In other words, if the new contents are inserted in a different browsing book, and if a jump to a page not currently in view in that browsing book is needed to show these newly inserted contents, then the flipping of the intervening thickness 112 is shown on that browsing book.

The above describes the animation process when new contents are inserted and displayed immediately in the browsing book through the selection and activation of a hyperlink. The same animation of intervening thickness 112 in the process of jumping to a page not currently in view is also shown when the insertion and immediate display of new contents in a browsing book are activated by the entering of a URL address, say, on the URL address field 204

In general, whenever a jump is activated in any way to a page not currently in view in the browsing book, whether the purpose of the jump is to display some recently inserted new contents or some other existing contents, an animation is shown showing the intervening thickness 112 moving across the computer screen such as that depicted in FIG. 1B.

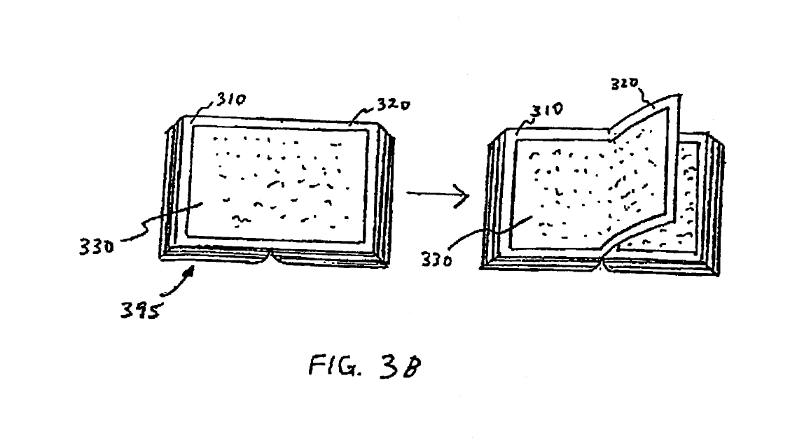

Because the Internet browsing book has many page-related operations, it would be more convenient to display a tool bar associated with each page (say, a tool bar 311 associated with the left hand page 310 and a tool bar 321 associated with the right hand page 320), as shown on the browsing book 300 in FIG. 3A. In one embodiment, this tool bar is placed on the edge of the pages involved. On the tool bars (311 and 321), there are buttons for Bookmarking operation (312 and 322), Annotation operation (313 and 323) and Fit-to-page operation (314 and 324), Display-as-centerfold (315 and 325), Make-floating-page (316 and 326), Stop-Internet-transfer (317 and 327), Delete-page (318 and 328) as well as a URL field (316 and 326).

Clicking the “Bookmarking” button 312 on the left-hand tool bar 311 creates a page-bookmark 340 on the left-hand page 310. The page-bookmark 340 can be labeled accordingly with text, color, number or other kinds of information. Clicking the “Annotation” button 313 on the left-hand tool bar 311 creates an annotation box 332 on the left-hand page 310 as well as an associated annotation-bookmark 343. The user can enter any text, sound, or video annotation into the annotation box 332 and the corresponding annotation-bookmark 343 can be labeled accordingly. The finger-bookmarks 345 is created when the browsing book is used in conjunction with a browsing device (U.S. Pat. No. 5,909,207, Browsing System and Method for Computer Information) that sends a signal to indicate that the user has placed a temporary “finger” onto this page to bookmark this page so that later using the controls on the browsing device he can rapidly return to this page.

Similar types of bookmarks (the page-bookmarks (340-342 and 350-352), the annotation-bookmarks (343, 344, 353, 354), and the finger-bookmarks (345, 346, 355, 356)) are grouped close together and/or are distinguished by colors, texts, or other mechanisms so that they can be easily distinguished.

The keyword-bookmarks 305, 306, 307, 308 are created when one clicks on a keyword, say the word “mouse” 334, on the right-hand page 320. The pages marked by the keyword-bookmarks 305-308 are pages that contain information related to “mouse” 334 that have been linked to it. Text, color, or other markings on the keyword-bookmarks 305-308 can be used to indicate the nature of the information present on those correspondingly marked pages (e.g., whether the information is a definition of the keyword involved, a detailed description of the keyword, some other related concepts, etc.)

The user can select any of the bookmarks (340-346, 350-356, and 305-308) and activate them to jump to any desired page rapidly. When a page is selected and jumped to, the thickness between the current page and the destination page is displayed and shown to move across the computer screen as in the case of jumping to a desired page in a physical book.

Selection and activation (with a mouse cursor and clicking of a mouse button, for example) of the “Fit-to-page” button 314 on the left hand page 310 converts the left hand page, say an HTML file that extends beyond the boundaries of the left hand page, into, say an image file that fits within the boundaries of the left hand page, and fit it onto the left hand page. The button 324 on the right hand page operates similarly.

Selection and activation of the “Display-as-centerfold” button 315 on the left hand page 310 converts the left hand page contents 330 to occupy both pages 310 and 320, as shown in the Display-as-centerfold Mode 395 (FIG. 3B).

Selection and activation of the “Make-floating-page” button on the left hand page 316 creates a separate window 360 from the browsing book and displays the contents of the left hand page 330 in the window 360. The button 326 on the right hand page 320 operates in a similar fashion.

Selection and activation of the “Stop-Internet-transfer” button on the left hand page 317 terminates the transfer of Internet information onto that page. The button 327 on the right hand page operates in a similar fashion.

Selection and activation of the “Delete-page” button on the left hand page 318 deletes the contents of the entire left hand page from the Internet browsing book. The rest of the contents on the other pages are shifted to fill in the blank space/page left behind by the delete operation. The button 328 on the right hand page operates in a similar fashion.

When a URL (Universal Resource Locator) is entered into the URL field 319 on the left hand page 310 and activated, the contents to which the URL point is brought into the Internet browsing book and placed at a location according to any one of the methods Mode 1-Mode 7 (229-235) described above. The button 329 on the right hand page 320 operates in a similar fashion.

For operations that execute upon the Internet browsing book that are global and not specific to the currently visible right hand or left hand page, buttons are also provided. One embodiment places these buttons on a Mode Toolbar 370 above the book, as shown in FIG. 3A. The Mode buttons 371-377 allow the user to select one of the 7 or more modes of displaying newly created contents (229-235). Another embodiment of the Mode Toolbar 390 can be positioned at the center of the browsing book 300.

The “Display-as-centerfold” button 380, when selected and activated, causes the contents to be displayed across both left and right pages, as shown in FIG. 3B, much like in the case of the currently available browsers such as Microsoft INTERNET EXPLORER® and Netscape COMMUNICATOR®. This allows more contents in a page to be visible. However, when the user moves on to other pages, unlike in the case of the currently available Internet browsers in which the older contents are simply replaced by the contents in the new pages in a “flash”, the browsing book in FIG. 3B could display a folding action of the currently visible centerfold page as the pages are flipped to reveal new contents on other page, as shown in FIG. 3B.

Currently most information on the Internet is encoded in the form of HTML (HyperText Markup Language) files. Currently Internet browsers such as Microsoft INTERNET EXPLORER® or Netscape COMMUNICATOR® display this Internet information in the form of HTML files on their main information display window. An HTML file can contain text and other multimedia information and can be of arbitrary length and width. So, when a HTML file longer and/or wider than the height and width of the computer screen or the Internet browser window is viewed, a scroll bar on the side (for up-down movement) and/or bottom (for left-right movement) of the browser window is usually available for scrolling the file up and down or left and right.

Hypertext files are linked by hyperlinks displayed on the pages of the hypertext files. When one of these links is selected and activated, the hypertext file to which it points is brought into view, either into the same window where the earlier hypertext file resides, or into a newly created Internet browser window.

In our current novel book-like Internet browsing system, this kind of hypertext display mechanism becomes a special case of our more general, page-based information display mechanism. In our system, if the information from the Internet is in the form of a hypertext page, it can be displayed on one of the pages of the browsing book 100 (FIG. 1). Scroll bars (219 and 220) can be made available as depicted in FIG. 2D for viewing various parts of the hypertext. However, unlike in the case of the current browsers such as Microsoft INTERNET EXPLORER® or Netscape COMMUNICATOR®, in which when new hypertext pages are activated either by the selection and activation of a visible hyperlink or the entering of a URL in an Internet address field, they would either appear in the same window in replacement of the earlier or in a newly created window, our Internet browsing book 100 (FIG. 1), being a much more complicated structure, provides 7 or more modes of display of newly created information, as depicted in FIG. 2F-2K and described above.

Since a large amount of Internet information has already been created in the form of hypertext, a user-friendly Internet browsing system should provide a seamless mechanism for switching between and integrating the display of both hypertext-based information as well as page-based information. Currently, an open electronic book format (OEB format), spearheaded by a number of major computer industry leaders, is in existence. One embodiment of a page-based information encoding system that can be used in conjunction with our book-like Internet browser is a OEB-DF format, an adaptation of the current OEB format to be described below. (“DF” is an acronym for “Digital Flip™” a trademark used by E-Book Systems, Inc. for its Digital Flip™ technology.)

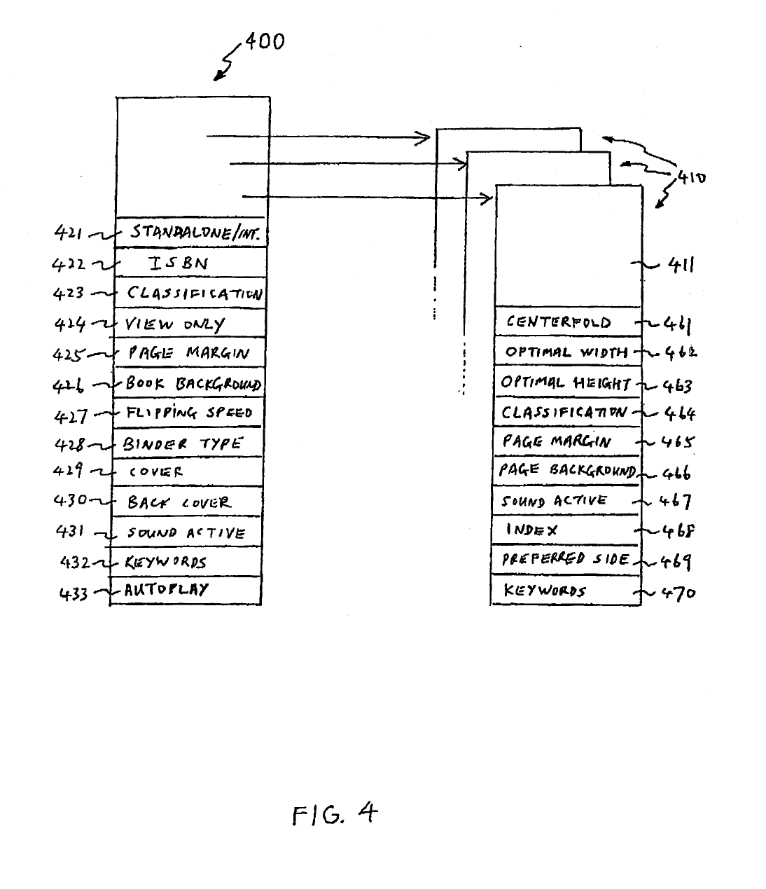

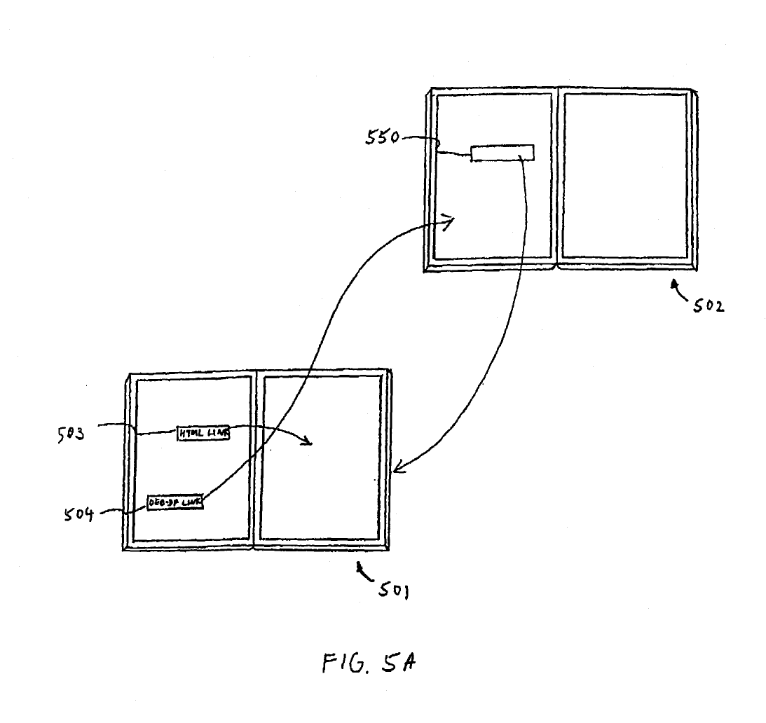

The basic OEB format has a book-like page-based organization. In other words, a “book” is basically constituted by a number of bound-together pages. OEB-DF extends this page-based description to contain information on a number of parameters as shown in FIG. 4. The OEB-DF book description 400 contains the basic OEB book description part 401 and the extensions. One of these extensions is the parameter STANDALONE/INTEGRATABLE 421. This parameter tells whatever browser or software that views the OEB-DF book whether to allow the book involved to be displayed with other books/contents in the same display window. If the STANDALONE/INTEGRATABLE 421 parameter is set to STANDALONE, then the book involved can only be viewed by itself—no other books/material may come before or after it in the same display window and be bound together with it into a thicker book. If the STANDALONE/INTEGRATABLE 421 parameter is set to INTEGRATABLE, then the book might be integrated with other books/material in the same display, as, say, part of a thicker/larger book, inserted into the original book using, say, one of the methods of insertion (229-235) described above.

Another example parameter can be the Library of Congress Catalogue Number ISBN 422. Yet another example parameter can be the BOOK CLASSIFICATION 423. Another example parameter can be the VIEW ONLY flag 424, which, when set, does not allow the viewer of the book to store a copy on his/her computer's hard disk. The PAGE MARGIN parameter 425 can specify the margin of the pages in the book. The BOOK BACKGROUND parameter 426 can specify the background color/pattern for the book. The FLIPPING SPEED parameter 427 can specify the preferred flipping speed of the book to be viewed. The BINDER TYPE parameter 428 can specify the type of binder for the book. The COVER parameter 429 can specify the cover pattern for the book. The BACK COVER parameter 430 can specify the back cover pattern for the book. The SOUND ACTIVE parameter 431 can specify whether the sound associated with the book should be played. The KEYWORDS parameter 432 can allow the author of the book to specify a series of keywords regarding the topics covered in the book.

Another parameter is the AUTOPLAY parameter 433. This parameter specifies whether the book, when downloaded and viewed/read, will automatically “play” itself by showing the flipping to the first page, playing any video or audio narration, pausing for some specified amount of time, flipping to the next page, etc. until the whole book is “played” (or until a certain point in the book is reached where a specification that the playing should stop is located).

Associated with the book description 400 can be a series of page descriptions 410. The page description 410 can also contain a basic OEB page description part 411 and some extensions. One of these extensions can be the CENTERFOLD parameter 461. This specifies whether the page is to be displayed as a CENTERFOLD that spreads across two pages instead of just one. An example of a CENTERFOLD display is shown in FIG. 3 (395). An opened book 395 displays a CENTERFOLD 330 across two pages. Another parameter is the OPTIMAL WIDTH 462 and OPTIMAL HEIGHT 463 parameters that can specify the most ideal viewing height and width dimensions of the page. Another parameter, CLASSIFICATION 464, can specify the category to which the contents of the book belong, such as “cars”, “celebrity”, etc.

Another parameter PAGE MARGIN 465 can specify the optimal page margin for a page. The parameter PAGE BACKGROUND 466 can specify the background color/pattern for the page. The SOUND ACTIVE parameter 467 can specify whether the sound associated with the page should be played when the page is viewed. The INDEX parameter 468 can specify whether this page should appear in the index of the book. The PREFERRED SIDE parameter 469 can specify whether a page should always appear on the left or right page, or that there is no preference for its appearance. The KEYWORDS parameter 470 can contain a string of keywords specified to be associated with the contents of the page.

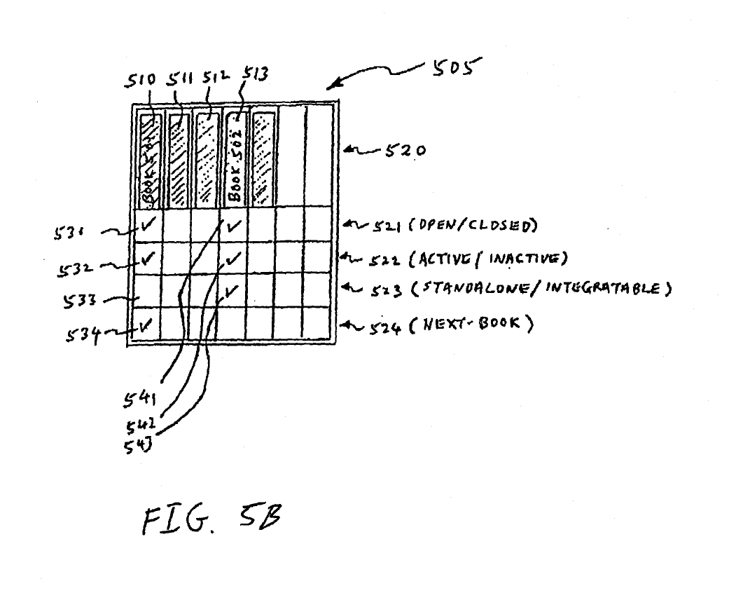

One embodiment of an Internet browsing system that caters for both the hypertext-based as well as page-based (say, OEB(DF)-based) information is depicted in FIG. 5.

This system consists of an Internet browser in the form of the browsing book described above that can display both HTML and OEB-DF contents. FIG. 5A depicts two instances of the browsing book (501 and 502), one currently displaying some HTML contents (501) and the other currently displaying some OEB-DF contents (502). There are two types of hyperlinks that can appear on any HTML or OEB-DF page. One type is the HTML hyperlink, an example 503 of which is shown on the left page of the HTML Browsing Book 501 and the other type is the OEB-DF hyperlink, an example 504 of which is also shown on the left page of the HTML Browsing Book 501.

A bookshelf 505 can also be displayed that contains the spine image/name 520 of a number of browsing books 510-513, as illustrated in FIG. 5B. Associated with each book (510-513) on the bookshelf 505 can be a number of book-state fields (521-524) that indicate whether the browsing book is open or closed (OPEN/CLOSED) (521), active or inactive (ACTIVE/INACTIVE) (522), whether the browsing book is standalone or can be integrated with other information (STANDALONE/INTEGRATABLE) (523), or whether the browsing book will be the “next-book” (NEXT-BOOK) (524) in which newly activated contents will appear. For example, the two currently opened browsing books 501 and 502 appear on the bookshelf 505 as spine-images 510 and 513 respectively. Their respective book-state fields 531 and 541 indicate that they are opened. The book-state fields 542 indicate that “Book 502” is currently active. The functions of these fields will be more apparent in the following description of the functioning of the browsing process.

Consider initially only the browsing book that contains the HTML file, “Book 501,” is open and active. The OPEN/CLOSED field 531 of the browsing book 501 will show OPEN. The ACTIVE/INACTIVE field 532 will show ACTIVE. The STANDALONE field 533 shows NOT-STANDALONE, and the NEXT-BOOK field 524, by default, shows NEXT-BOOK 534.

When a HTML-type hyperlink, such as hyperlink 503 is selected and activated, since the browsing book 501 is currently the NEXT-BOOK to display new contents, the target contents will appear in some of pages in the HTML browsing book 501, to be placed in the browsing book 501 according to, for example, one of the 7 methods described above (Modes 1-7, FIG. 2F-J).

Now consider that a OEB(DF)-type link, such as hyperlink 504, is selected and activated. This link points to a OEBDF-type book 502 whose spine image 513 appears on the bookshelf 505. The STANDALONE/INTEGRATABLE book-state field 543 shows that this book is to be displayed as a STANDALONE book. The target contents which are in the OEB-DF format will appear as a separate window 502 as shown in FIG. 5. Now, suppose a link 550 in the open OEB-DF book 502 is selected and activated, the contents to which the link 550 points will appear elsewhere other than in the window containing the OEB-DF book 502 because the OEB-DF book 502 is to be displayed as a STANDALONE book, as specified by its associated STANDALONE/INTEGRABLE parameter 543. The contents to which link 550 points will hence appear in whichever window/browsing book that is the current NEXT-BOOK, and in this case, the opened browsing book 501.

The current NEXT-BOOK is selectable by the user by clicking on the appropriate field in the bookshelf 505 and only ONE NEXT-BOOK at any one time can be specified. No book that is STANDALONE can be the NEXT-BOOK. Furthermore, a book must be OPEN before it can be the NEXT-BOOK. If none of the NEXT-BOOK fields on the bookshelf 505 contains a NEXT-BOOK selection, then a new book will be created to contain the new contents created by the activation of a hyperlink. Unless this newly opened book is STANDALONE, it will automatically become the NEXT-BOOK by default since no other book just before this is a NEXT-BOOK. A currently ACTIVE book that is not STANDALONE will also become the NEXT-BOOK by default.

Because the speed of information transmission across the Internet is usually limited by the so-called bandwidth of the

Internet delivery medium (such as telephone wires), and because often large image/video/audio files may be involved in the transmission, an important issue to address is the method by which to predict what the users would like to view next while they are viewing the currently visible contents on the computer screen. This way, information can be pre-delivered so that when the user selects for the next-to-be-viewed contents, the contents are already delivered into the computer so that users can view them immediately without waiting a significant amount of time for the information to be “downloaded.” In hypertext displays of information from the Internet, it is difficult to predict what the next page of information that the user desires to bring into his/her computer to view through the selection and activation of a hyperlink will be, since he/she could potentially select any hyperlink and these hyperlinked pages are in no particular order but are instead linked in a complex manner in a network.

However, our page-based method of organizing information on the Internet confers an advantage with regards to predicting the next desired information. Because information is now organized in a sequential manner, the system can pre-download a few following pages while the user is viewing the currently visible contents on the computer screen. It is most likely that the user would select to view the pages immediately subsequent to the current page. Only occasionally will a user select to skip over many pages, especially since the information is already organized in the sequential, page-based manner. Therefore, in the vast majority of times, the system using this method of pre-delivering Internet information would allow the user to have a very pleasant reading/browsing experience without many interruptions or much waiting (for downloading to complete).

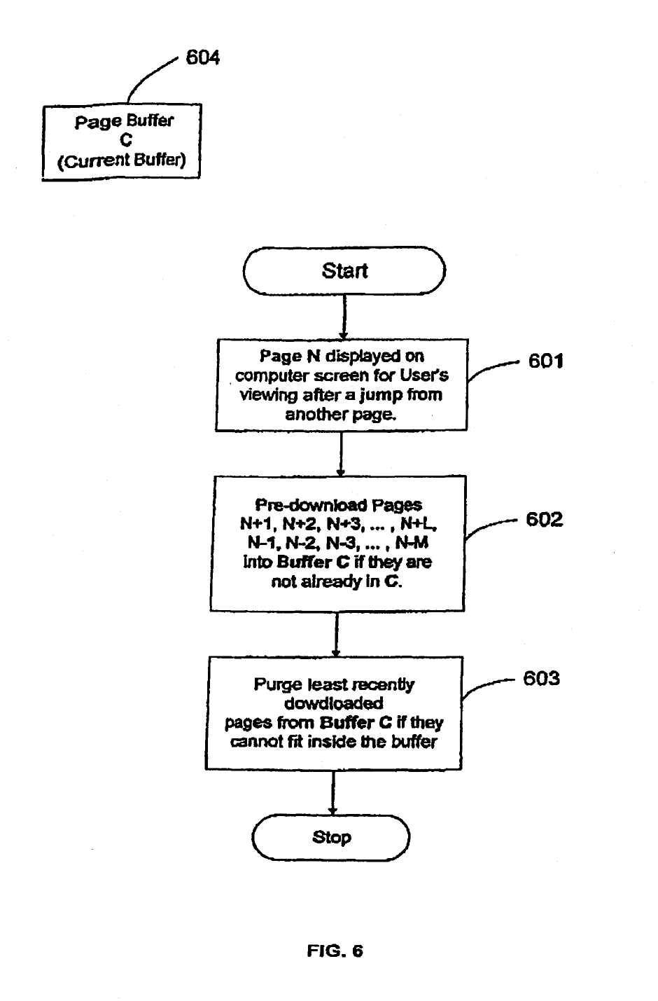

FIG. 6 depicts the operation of a prediction/streaming algorithm as related to viewing page-based information downloaded from the Internet. FIG. 6 depicts what happens when a page is first entered (after a jump from another page or when the book is first activated) and displayed on the computer screen for user's viewing. A Page Buffer C (604) is available to store pages that are likely to be viewed by the user in the near future.

In Step 601 Page N is displayed on the computer screen for user viewing (say, after a jump from another page). In Step 602, all the pages with a certain range of Page N (succeeding pages N+1, N+2, . . . , N+L, and preceding pages N−1, N−2, . . . , N−M) are pre-downloaded into the Buffer C if they are not already in Buffer C. Usually, L will be larger than M as it is more likely that the user will flip forward rather than backward.

In Step 603, all the least recently downloaded pages that cannot be fitted within Buffer C (604) are purged.

Each page in the Buffer C (604) is given a recency value indicating how recent it was that it was downloaded and stored in Buffer C. Whenever a new session of pre-downloading takes place, all previous pages' recency values (those pages that are currently in Buffer C (604) just before the pre-downloading) are incremented by 1. Then, for those pages that are just pre-downloaded and those that are already in Buffer C (604) that are within the range N+1, N+2, N+L, N−1, N−2, . . . , N−M, they are given a recency value of 1.

As the user sequentially flips forward or backward, pages further forward or further backward are pre-downloaded accordingly. Pages that fall outside the range N+1, N+2, . . . , N+L, N−1, . . . , N−2, . . . , N−M will have their recency values incremented by 1, while pages that are within the range will have their recency values set to 1.

This algorithm ensures that 1. pre-downloaded pages that are most likely to be selected by the user are there (on the hard disk) for the system to retrieve and display on the screen for the user to browse, and 2. the Page Buffer C (604) is most efficiently utilized for the purpose of display on the screen for the user to browse.

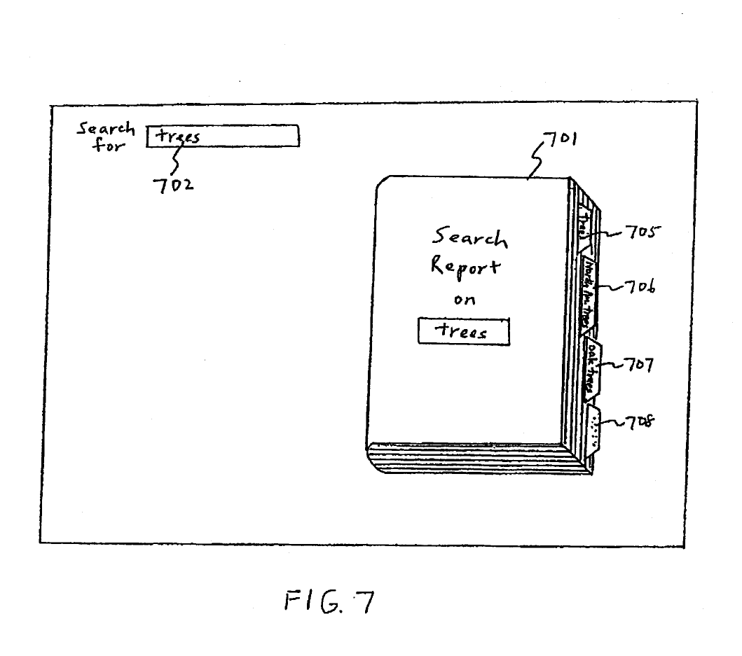

The book-form representation of Internet information confers another advantage to the search and organization of Internet information. Currently, there are many so-called search engines available in the market to search for Internet information. Typically, the user types in a search keyword and a number of Websites/Internet documents that have relationship to the keyword would be located by the search engine and fed to the user's computer and downloaded and displayed, on the user's Internet browser, as a collection of hyperlinks to these Websites/Internet documents. The number of hyperlinks, however, can often run to thousands and are very difficult to view and read. Our Internet browsing book provides an excellent method to further organize this information for ease of search. Based on the keywords present in the OEB-DF format documents on which search has been performed, our specialized search engine can further classify the Websites/documents found through the search process and divide them into sections as shown in FIG. 7. Suppose a search is being performed on the keyword “tree” 702. The search report 701 created by our specialized search engine which searches sites that contains OEB-DF format Internet documents (or other documents containing detailed classification information) can further classify the documents found under “North American trees”, “Oak trees”, etc. using bookmarks 705-708 as separators.

While particular embodiments of the present invention have been illustrated and described, it will be appreciated that numerous changes and modifications will occur to those skilled in the art, and it is intended that the appended claims cover all those changes and modifications which fall within the spirit and scope of the present invention.

Obviously numerous modifications and variations of the present invention are possible in light of the above teachings. It is therefore to be understood that within the scope of the appended claims, the invention may be practiced otherwise than specifically described herein.

1. A user interface, comprising:
an electronic book image comprising flipping pages configured to display a current subset of an electronic data set, said electronic data set previously downloaded from a remote memory site;
a book thickness indicator configured to indicate a current position of said current subset in said previously downloaded electronic data set;
a selection mechanism configured to enable selection of a new data subset for downloading; and
a selection organizer configured to enable selection of a point of directed downloading for directly inserting of said new data subset relative to said current subset, said point of directed downloading for directly inserting being selectable from a list comprising
a point of directed downloading for directly inserting at the end of said electronic data set, and
a point of directed downloading for directly inserting at the beginning of or within said electronic data set.
